(19) United States
(12) Patent Application Publication
(10) Pub. No.: US 2010/0211960 A1
(43) Pub. Date: Aug. 19, 2010

(54) Characterizing User Information

(75) Inventors: Sarah Sirajuddin, Sunnyvale, CA (US); Xuefu Wang, Los Altos, CA (US); Angshuman Guha, Los Gatos, CA (US); Oren E. Zamir, Los Altos, CA (US); Aitan Weinberg, New York, NY (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/372,576

(22) Filed: Feb. 17, 2009

(51) Int. Cl. G06F 9/46; G06F 3/00; G06F 17/30

(52) U.S. Cl. 719/313; 715/762; 707/E17.039

(57) ABSTRACT

Among other disclosed subject matter, a computer-implemented method for characterizing user information includes receiving a plurality of identifiers associated with respective users. The method includes identifying, using the plurality of identifiers, any information portions in an information collection relating to at least one of the users, the information collection reflecting network activities by the users. The method includes generating a record that includes the plurality of identifiers associated with the corresponding information portions. The method includes identifying at least one of the information portions as corresponding to a category established for user classification. The method includes identifying a subset of the plurality of identifiers as associated with the category; and. The method includes providing a list to a content provider from whom the plurality of identifiers was received, the list including the subset of the plurality of identifiers and indicating that the subset is associated with the category.

### TECHNICAL FIELD

This document relates to information processing.

### BACKGROUND

Contents are distributed in computer systems or by other technologies in different situations. For example, advertisements can be used in an attempt to inform people about a wide variety of products, goods, and services. Generally, advertisers may seek to target the contents of their advertising to the intended audience or viewers.

Advertisements can take many forms, such as printed material, commercials on 10 television and radio, billboards, etc. These advertisements can be placed without detailed knowledge about the potential viewers, for reaching potential customers who encounter the advertisement coincidentally. Advertisements are sometimes placed to target a particular demographic group (e.g., ads for toys in a children‘s’ TV show, billboards for tires along a roadside) in order to increase the chances of reaching potential customers.

### SUMMARY

The invention relates to characterizing user information.

In a first aspect, a computer-implemented method for characterizing user information includes receiving a plurality of identifiers associated with respective users.

The method includes identifying, using the plurality of identifiers, any information portions in an information collection relating to at least one of the users, the information collection reflecting network activities by the users. The method includes generating a record that includes the plurality of identifiers associated with the corresponding information portions. The method includes identifying at least one of the information portions as corresponding to a category established for user classification. The method includes identifying a subset of the plurality of identifiers as associated with the category; and. The method includes providing a list to a content provider from whom the plurality of identifiers was received, the list including the subset of the plurality of identifiers and indicating that the subset is associated with the category.

Implementations can include any, all or none of the following features. The method can further include modifying the list to disassociate the identifiers from at least one of a specific user name and a specific Internet Protocol address. The method can further include modifying the list to disassociate the identifiers from at least one of specific user interest information and specific user browser history. The method can further include providing the list also to another content provider. The method can further include identifying another category established for user classification associated with a set of user identifiers; determining an amount of overlap between the subset of the plurality of identifiers and the set of user identifiers; and upon determining that the amount of overlap is at least a threshold level, associating the other category with a correlation indicator regarding the category. The method can further include modifying the list to disassociate the identifiers from at least one of specific user interest information, specific user browser history, and specific user name. The method can further include identifying a content distribution relating to the category that is scheduled to be performed; identifying the other category as associated with the category using the correlation indicator; and performing the content distribution toward at least users associated with the other category based on the correlation indicator. The other category can currently be associated with a correlation indicator regarding the category, and the method can further include, upon determining that the amount of overlap is less than a threshold level, recording the determination in association with the correlation indicator. The method can further include determining whether to remove the correlation indicator based on at least the determination. The other category can currently be associated with a correlation indicator regarding the category, and the method can further include, upon determining that the amount of overlap is at least a threshold level, generating a validation message regarding the correlation indicator based on the determination. The plurality of identifiers can be included in a user list that essentially comprises the plurality of identifiers, and the information portions can be identified using identifiers in the information collection. A content provider can have generated a list including the plurality of identifiers upon detecting an event occurrence regarding each of the respective users. The event occurrence can include that the respective users accessed a resource controlled by the content provider. The method can further include identifying, for each of the respective users associated with the plurality of identifiers, a pre-event history in the information collection, the pre-event history including at least one of the information portions and relating to a time before the event occurrence for the respective user; and detecting, for at least one of the pre-event histories, a history pattern of user behavior leading to the event occurrence. The method can further include identifying another user as a potential candidate for being added to the users associated with the plurality of identifiers, the user identified by searching the information collection using the history pattern.

In a second aspect, a computer program product is tangibly embodied in a computer-readable storage medium and includes instructions that when executed by a processor perform a method for user-specific content presentation. The method includes receiving a plurality of identifiers associated with respective users The method includes identifying, using the plurality of identifiers, any information portions in an information collection relating to at least one of the users, the information collection reflecting network activities by the users. The method includes generating a record that includes the plurality of identifiers associated with the corresponding information portions. The method includes identifying at least one of the information portions as corresponding to a category established for user classification. The method includes identifying a subset of the plurality of identifiers as associated with the category. The method includes providing a list to a content provider from whom the plurality of identifiers was received, the list including the subset of the plurality of identifiers and indicating that the subset is associated with the category.

In a third aspect, a computer program product is tangibly embodied in a computer-readable storage medium and includes instructions that, when executed, generate on a display device a graphical user interface for characterizing user information. The graphical user interface includes an identifier area for a user to submit a plurality of identifiers associated with respective individuals. The graphical user interface includes an attribute area for the user to enter a selection any of a plurality of attributes associated with the individuals, the attributes obtained from an information collection using the plurality of identifiers, the information collection reflecting network activities by the individuals, wherein an identifier collection of those of the users associated with a selected attribute is generated in response to the selection.

Implementations can include any, all or none of the following features. The plurality of identifiers can be included in a user list that essentially comprises the plurality of identifiers, and the information portions can be identified using identifiers in the information collection. The user can be a content provider from whom the plurality of identifiers was received, and the graphical user interface can further include a content distribution area configured for initiating a content distribution using a list that includes the subset of the plurality of identifiers and indicates that the subset is associated with the category. The graphical user interface can further include a sharing function for the content provider to share the list with another content provider.

Implementations can provide any, all or none of the following advantages. Content distribution can be improved. A collection of user identifiers can be enhanced with information relating to one or more users. A content provider such as an advertiser can benefit from accessing enhanced user list.

The details of one or more embodiments are set forth in the accompanying drawings and the description below. Other features and advantages will be apparent from the description and drawings, and from the claims.

### DESCRIPTION OF DRAWINGS

FIG. 1 shows an example system that can be used for content distribution.

FIG. 2 schematically shows an example process of associating information with one or more user identifiers.

FIG. 3 shows an example user interface that can be used for characterizing user information.

FIG. 4 shows an example method that can be performed to characterize user information.

FIG. 5 is a block diagram of a computing system that can be used in connection with computer-implemented methods described in this document.

Like reference symbols in the various drawings indicate like elements.

### DETAILED DESCRIPTION

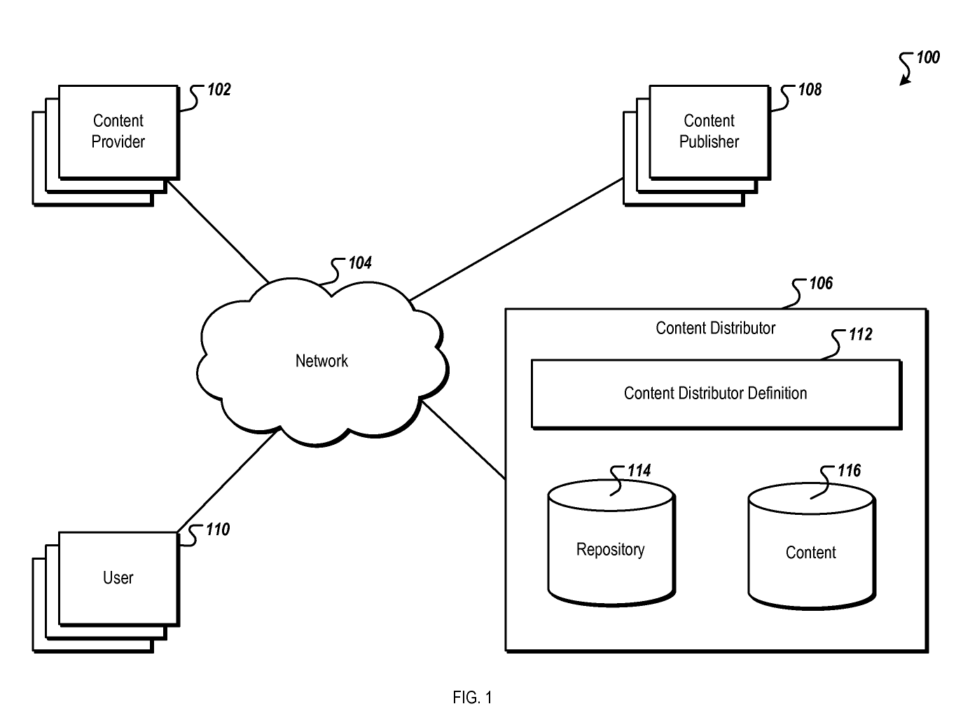

FIG. 1 shows an example system 100 that can be used for content distribution. A content provider system 102 can provide content over any kind of network 104. For example, a content provider can be an advertiser that wishes to present advertisements to one or more potential customers in an online environment, such as on a website or in an online forum. A content distributor system 106 can communicate with the content provider system 102 over the network 104. For example, an advertiser can provide an advertisement, such as multimedia or text, and/or other content to an advertisement distributor. In some implementations, the content distributor system 106 can distribute content to users over the network 104 based on a collection of user identifiers, such as a user list. For example, the content provider system can retrieve information relating to one or more user identities noted in a collection of user identifiers, preferably while anonymizing or minimizing collection of certain personally identifiable information related to the user identities. In some implementations, retrieval of related information can be part of analyzing a user list and creating an enhanced list that can be used in content distribution.

The content distributor system 106 can communicate over the network 104 with a content publisher system 108. For example, the content publisher 108 can publish a webpage or other content that presents advertisements or other distributed content, optionally along with other content. A content publisher system can publish a forum, an email service, or a massively multiplayer online game, to name just a few more examples.

Content can be provided by the content publisher system 108 to a user system 110 over the network 104. For example a user can browse content and/or advertisements provided by the content publisher system 108 on a website. The content distributor system 106 can specify if a user is to be provided with content. For example, an advertisement may be presented to a user visiting a particular website if the user and/or the website meets a condition defined in the content distributor system. Content can be provided to users based on one or more criteria.

Content, such as advertisements, can be targeted to a user system 110. For example, in a targeted advertising system, a user system 110 searches for a keyword or keywords, and the content distributor system 106 provides advertisements to be displayed on a content publisher's website 108 that is relevant to those particular keywords. The content publisher system 108 can opt out of presenting content targeted to a specific user. In some implementations, the content provider system 102 may have or seek a list of users. Moreover, a method for distributing content to a user system 110 can be based on based on a collection of user identifiers, such as a user list. In some implementations, a list of users can include but is not limited to, for example, user names, anonymized user identifier numbers, and the like, internet protocol (IP) addresses (which may be truncated to protect privacy), cookies and/or other data for identifying users, to name a few examples. The content provider system 102 can provide a list of users to the content distributor system 106. The content provider system 102 may wish to target advertisements to additional users, or a subset of users based on other dimensions such as user or website demographics, to name two examples. The content provider system 102 may be willing to pay different amounts of compensation for content distribution to users targeted for a particular dimension. For example, an advertiser may wish to pay more for an advertisement to a 20-29 year old male than other demographic groups. In another example, an advertiser may wish to advertise a product to a user who backed out of an online purchase during a checkout process.

The content distributor system 106 can include a content distributor definition component 112. In some implementations, the content distributor definition component 112 can include a software, hardware and/or firmware module that provides controls for defining users, demographics, advertisements, compensation amounts, and/or other controls, to name just a few examples.

The content distributor system 106 can include a repository 114 of information. In some implementations, the repository 114 stores information about users, such as collections of user identities, demographics, preferences, and/or other information about users and user activity, to name a few examples. In some implementations, certain information associated with users is anonymized or partially redacted. For example, user identities (such as user names or user electronic mail addresses) can be replaced in whole or in part with a numerical string, user Internet Protocol addresses can be processed to eliminate some information such as, for example, the class C and class D subdomain information, user browsing history can be disassociated with a particular user identity and replaced with a user interest category, and user interest categories can be generalized to minimize association with specific user identities or user browsing histories, and the like.

The content distributor system 106 can include a content database 116. For example, the content database 116 can contain content such as advertisements that are configured for distribution to one or more users.

In an example scenario, the content provider system 102 may wish to target an advertisement or other content distribution to users on a list, but only if a certain keyword occurs in relation to the distribution, for example because the keyword occurs on the page or other resource where the content is to be published. The content provider can define in a user interface generated by the content distributor definition component 112 that they wish to advertise to users on a list who meet a certain criteria and other users not specified in the list that meet the same criteria. The user information can be contained and/or stored in the repository 114. The content provider system 102 can upload an advertisement or choose an advertisement which is stored in the content database 116. The content distributor system 106 determines if the user system 110 is to receive the advertisement when the user visits a website provided by the content publisher system 108.

In some implementations, the system 100 can use the information in repository 114 to associate one or more user identifiers with related information, such as by enhancing a list of users with information relevant to content distribution. For example, a user list can be generated based on which have contacted a content provider, such as by visiting a page or other resource operated by the content provider.

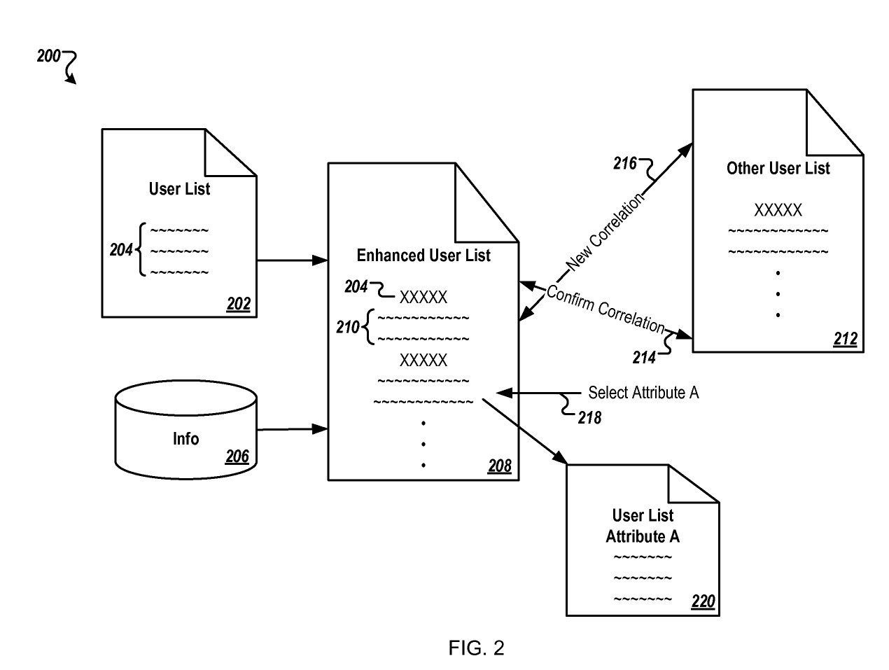

FIG. 2 schematically shows an example process 200 of associating information with one or more user identifiers. Here, a user list 202 can include one or more user identifiers 204. In some implementations, the user identifier(s) 204 can be obtained from a content provider such as an advertiser, who has registered the user identifier(s) when visits have occurred on the content provider's page or other resource. For example, the content provider can submit the user list 202 such that it includes essentially only cookie IDs and/or any other type of identifiers associated with individual users. The user list can be submitted in any of multiple ways, such as by electronic transmission from the content provider system 102.

In this example, information 206 is available or can be obtained. In some implementations, the information 206 can include an information collection that relates to one or more users. For example, the information 206 can reflect network activities by the user(s), such as by the information 206 being gathered by the content distributor system 106 upon earlier content distributions to one or more users. For example, contents such as advertisements can be distributed to one or more of the user systems 110 and the content distribution system 102 can monitor whether any user selects or otherwise interacts with a content portion, such as by clicking on the content portion. In some implementations, the information 206 is attributed to individual users using user identifiers similar or identical to the identifiers 204, such as cookie IDs.

The user list 202 and the information 206 can be used to associate information relating to one or more users with the user identifiers 204. In some implementations, a record such as an enhanced user list 208 can be generated. The record can include one or more of the user identifiers 204 from the user list 202 and one or more information portions 210 associated with the respective user identifier 204. For example, each of the user identifiers 204 can be associated with information about the corresponding user obtained from the information 206. Other forms of records can be generated, such as a database and/or a user profile document, for example.

The generated record can be used for one or more purposes. In some implementations, the record can be generated as part of analyzing the information 206. For example, the user list 202 can represent a selected slice of the total number of identifiers that have corresponding data included in the information 206, and the analysis can include taking a selected view on the information 206 from the perspective of the subset of identifiers in the user list 202.

As another example, the information 206 can be used to characterize the users represented by the user identifiers 204, such as based on one or more of demographic parameters, interests and browsing patters, to name some examples. For example, the information 206 can indicate demographics, interest and/or browsing history associated with one or more user identifiers, and such information can be grouped with the respective user identifiers 204 obtained from the user list 202. In some implementations, a record such as the enhanced user list 208 can be provided to one or more entities, such as to the content provider that submitted the user list 202. For example, the enhanced user list 208 can help the content provider select content such as advertisements for distribution and/or to evaluate distribution channels. In some implementations, one or more other content providers can be provided access to the generated record.

In some implementations, the enhanced user list 208 can be used in evaluating existing information, such as known correlations between categories of users. For example, assume that in the advertising industry it is recognized that users categorized as interested in booking a travel package to a remote destination have a greater than average likelihood of being interested in buying a digital camera. This can be considered a correlation between the categories “interested in booking a travel package” and “interested in buying a digital camera”. For example, users classified in the first group may then have a greater chance of being found among a list of people classified according to the second group.

In some implementations, a generated record such as the enhanced user list 208 can be used in confirming and/or validating an existing correlation. For example, the enhanced user list 208 can include user identifiers for which the information 210 indicates that the users are categorized as being “interested in booking a travel package”. Moreover, another user list 212 can include user identifiers for which corresponding information indicates that the users are categorized as being “interested in buying a digital camera”. To determine whether the correlation between the categories can be confirmed, it can be determined whether there is substantial correlation between the respective users identified by the list 208 and the list 212. For example, if a significant number of users (such as a certain percentage, say at least 5%) on the list 208 also occur on the list 212, then the correlation can be considered valid and can therefore be confirmed, as schematically illustrated by a confirmation 214. Other ways of evaluating correlation, including other measures of significant user overlap, can be used.

The correlation can be performed through any well known method, such as but not limited to, collaborative filtering, parametric methods such as Pearson correlation, and non-parametric methods such as Chi-squared correlation, and the like.

In another example, the list 208 and the list 212 can indicate that there is no significant correlation between the categories, for example because the users on the respective lists do not substantially overlap. When correlation cannot be confirmed, an opposite message can be generated based on the analysis, such as to invalidate an existing correlation or to register that the correlation may need further investigation.

In some implementations, a generated record such as the enhanced user list 208 can be used in confirming and/or validating an existing correlation. For example, the enhanced user list 208 can relate to users categorized as being “interested in booking a travel package”, as in the previous example. On the contrary, the user list 212 in this example relates to users categorized as being “interested in modern art”. Assume, moreover, that no correlation between these respective categories has previously been identified. That is, in this example, the advertising industry may generally not believe that any significant overlap exists between the users who are entered in these categories.

However, in some implementations an analysis of information obtained and recorded in the list 208 can indicate otherwise. For example, the lists 208 and 212 can indicate that there is significant overlap between the groups of users in the respective categories. In other words, a correlation may be discovered that was not previously known. For example, the correlation may have developed only recently and the lists 208 and 212 can be an efficient way of detecting its existence. In some implementations, a new correlation 216 can be identified. For example, the new correlation can be indicated in a suitable message, such as to a content provider who may wish to target the users on either of the lists with content relating to the category of the other list. Other uses can be made of a detected correlation.

In some implementations, a generated record such as the enhanced user list 208 can be used in selecting recipients for content distribution. For example, the content provider who submits the user list 208 is presented with the enhanced user list 208. The list 208, moreover, can include the information 210 such as one or more attributes associated with the respective user(s). In some implementations, the content provider can select one or more attributes from the list 208, as schematically illustrated by selection 218, and can in response be provided with a subset including any of the user identifiers 204 associated with the selected attribute (e.g., associated with “Attribute A”). For example, an attribute specific list 220 can be generated that includes the identifier(s) selected as satisfying the content provider's criterion. In some implementations, the user list 220 can be provided to the content provider for use in targeting a content distribution to any or all listed user identifiers.

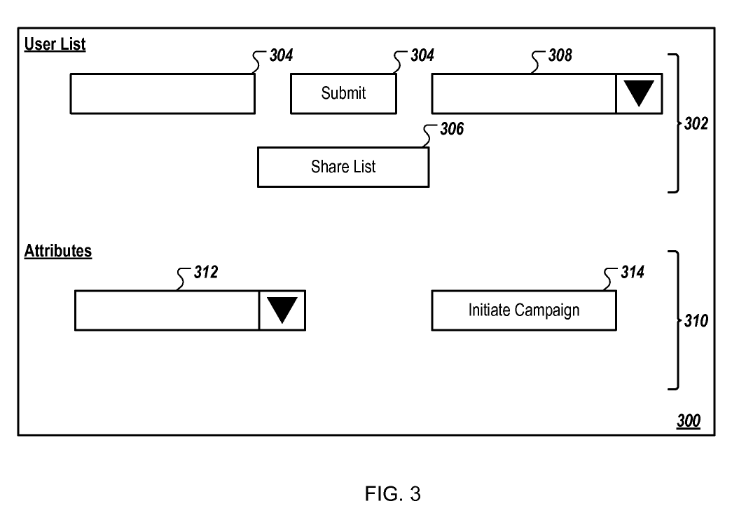

FIG. 3 shows an example user interface 300 that can be used for characterizing user information. The user interface 300 can be generated by a processor executing instructions in a computer-readable medium, for example in the system 100. In some implementations, the GUI 300 can be generated by the content distribution system 102.

Here, the user interface 300 includes a user list area 302 where the content provider can identify one or more user lists to be employed in the analysis. In some implementations, the content provider can enter a user list and submit the list for uploading using a control 304. For example, the content provider may have compiled the user list from user identifiers of any user who has visited a page or other resource controlled by the content provider. The content provider can use a control 306 to initiate sharing of a user list with one or more other entities. For example, the content provider can share a user list with other content providers interested in directing content distributions at selected groups of users.

The content provider can use a selection control 308 to select one of more existing user lists that are being made available. In some implementations, this can include a user list made available by a content distributor and/or another content provider for use by one or more content providers. For example, a user list can be listed in the control 308 after it has been submitted for sharing using the control 306.

Here, the user interface 300 can include an attributes area 310 that can be used for selecting an attribute regarding one or more user identifiers. In some implementations, the attributes area 310 can include a control 312 for choosing at least one attribute. For example, the attribute(s) can be obtained from a generated record such as the enhanced user list 208 and can be used to populate the control 312. In some implementations, selecting an attribute using the control 312 can result in the list 220 (FIG. 2) being provided.

In some implementations, the user interface 300 can include a control 314 for initiating a content distribution, such as an advertisement campaign. For example, a content provider can obtain a list of user identifiers that match one or more specific attributes and can initiate a campaign directed to the corresponding users by initiating the control 314. Other ways of initiating a content distribution can be used.

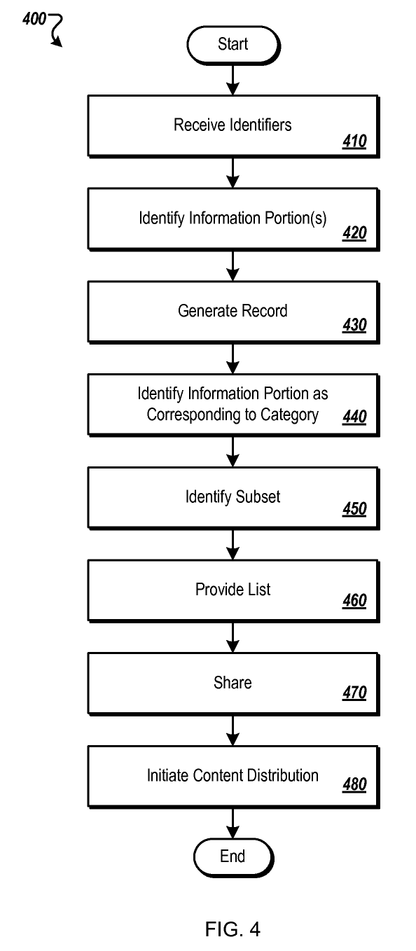

FIG. 4 is a flow chart of an example method 400 that can be performed to characterize user information. In some implementations, the method 400 can be performed by a processor executing instructions in a computer-readable medium, such as in the system 100.

In step 410, a plurality of identifiers associated with respective users is received. For example, the user list 202 can be submitted from the content provider system 102 using the GUI 300.

In step 420, any information portions in an information collection relating to at least one of the users are identified using the plurality of identifiers. The information collection reflects network activities by the users. For example, the content distribution system 102 can access the information in the repository 114 and retrieve any information portions pertaining to user(s) identified by a user list. Retrieved information can relate to demographics, interests and/or browsing history, to name a few examples.

In step 430, a record is generated that includes the plurality of identifiers associated with the corresponding information portions. For example, the enhanced user list 208 can be generated.

In step 440, at least one of the information portions is identified as corresponding to a category established for user classification. For example, any of the information 210 can indicate that a user has an interest in purchasing a digital camera.

In step 450, a subset of the plurality of identifiers is identified as associated with the category. For example, it can be identified which of the user identifiers 204 are associated with a detected user interest in purchasing a digital camera.

In step 460, a list is provided to a content provider from whom the plurality of identifiers was received. The list can include the subset of the plurality of identifiers and indicate that the subset is associated with the category. For example, the attribute-specific list 220 can be provided.

In step 470, a generated record can be shared with one or more entities. For example, the enhanced user list 208 can be shared with a content provider in the system 100, such as based on an initiating content provider activating the control 306.

In step 480, a content distribution can be initiated. For example, a distribution of content can be initiated to any user(s) mentioned on the list 220 as being associated with an attribute selected in the enhanced user list 208.

In some implementations, more or fewer steps can be performed. As another example, one or more steps can be performed in another order.

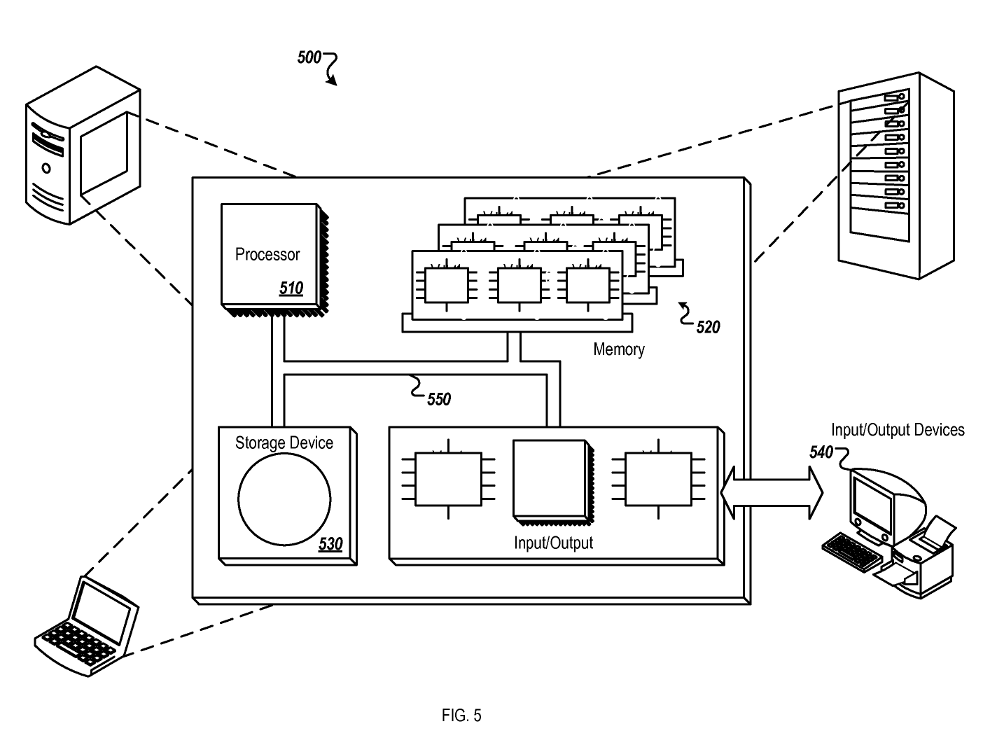

FIG. 5 is a schematic diagram of a generic computer system 500. The system 500 can be used for the operations described in association with any of the computer-implement methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method for characterizing user information, the method comprising:
receiving a plurality of identifiers associated with respective users;
identifying, using the plurality of identifiers, any information portions in an information collection relating to at least one of the users, the information collection reflecting network activities by the users;
generating a record that includes the plurality of identifiers associated with the corresponding information portions;
identifying at least one of the information portions as corresponding to a category established for user classification;
identifying a subset of the plurality of identifiers as associated with the category; and
providing a list to a content provider from whom the plurality of identifiers was received, the list including the subset of the plurality of identifiers and indicating that the subset is associated with the category.

2. The computer-implemented method of claim 1, further comprising:
modifying the list to disassociate the identifiers from at least one of a specific user name and a specific Internet Protocol address.

3. The computer-implemented method of claim 2, further comprising:
modifying the list to disassociate the identifiers from at least one of specific user interest information and specific user browser history.

4. The computer-implemented method of claim 1, further comprising:
providing the list also to another content provider.

5. The computer-implemented method of claim 1, further comprising:
identifying another category established for user classification associated with a set of user identifiers;
determining an amount of overlap between the subset of the plurality of identifiers and the set of user identifiers; and
upon determining that the amount of overlap is at least a threshold level, associating the other category with a correlation indicator regarding the category.

6. The computer-implemented method of claim 5, further comprising:
modifying the list to disassociate the identifiers from at least one of specific user interest information, specific user browser history, and specific user name.

7. The computer-implemented method of claim 5, further comprising:
identifying a content distribution relating to the category that is scheduled to be performed;
identifying the other category as associated with the category using the correlation indicator; and
performing the content distribution toward at least users associated with the other category based on the correlation indicator.

8. The computer-implemented method of claim 5, wherein the other category is currently associated with a correlation indicator regarding the category, the method further comprising:
upon determining that the amount of overlap is less than a threshold level, recording the determination in association with the correlation indicator.

9. The computer-implemented method of claim 8, further comprising:
determining whether to remove the correlation indicator based on at least the determination.

10. The computer-implemented method of claim 5, wherein the other category is currently associated with a correlation indicator regarding the category, the method further comprising:
upon determining that the amount of overlap is at least a threshold level, generating a validation message regarding the correlation indicator based on the determination.

11. The computer-implemented method of claim 1, wherein the plurality of identifiers is included in a user list that essentially comprises the plurality of identifiers, and wherein the information portions are identified using identifiers in the information collection.

12. The computer-implemented method of claim 1, wherein a content provider generated a list including the plurality of identifiers upon detecting an event occurrence regarding each of the respective users.

13. The computer-implemented method of claim 12, wherein the event occurrence includes that the respective users accessed a resource controlled by the content provider.

14. The computer-implemented method of claim 12, further comprising:
identifying, for each of the respective users associated with the plurality of identifiers, a pre-event history in the information collection, the pre-event history including at least one of the information portions and relating to a time before the event occurrence for the respective user; and
detecting, for at least one of the pre-event histories, a history pattern of user behavior leading to the event occurrence.

15. The computer-implemented method of claim 14, further comprising:
identifying another user as a potential candidate for being added to the users associated with the plurality of identifiers, the user identified by searching the information collection using the history pattern.

16. A computer program product tangibly embodied in a computer-readable storage medium and comprising instructions that when executed by a processor perform a method for user-specific content presentation, the method comprising:
receiving a plurality of identifiers associated with respective users;
identifying, using the plurality of identifiers, any information portions in an information collection relating to at least one of the users, the information collection reflecting network activities by the users;
generating a record that includes the plurality of identifiers associated with the corresponding information portions;
identifying at least one of the information portions as corresponding to a category established for user classification;
identifying a subset of the plurality of identifiers as associated with the category; and
providing a list to a content provider from whom the plurality of identifiers was received, the list including the subset of the plurality of identifiers and indicating that the subset is associated with the category.

17. A computer program product tangibly embodied in a computer-readable storage medium, the computer program product including instructions that, when executed, generate on a display device a graphical user interface for characterizing user information, the graphical user interface comprising:
an identifier area for a user to submit a plurality of identifiers associated with respective individuals; and
an attribute area for the user to enter a selection any of a plurality of attributes associated with the individuals, the attributes obtained from an information collection using the plurality of identifiers, the information collection reflecting network activities by the individuals, wherein an identifier collection of those of the users associated with a selected attribute is generated in response to the selection.

18. The computer program product of claim 17, wherein the plurality of identifiers is included in a user list that essentially comprises the plurality of identifiers, and wherein the information portions are identified using identifiers in the information collection.

19. The computer program product of claim 17, wherein the user is a content provider from whom the plurality of identifiers was received, and wherein the graphical user interface further includes:
a content distribution area configured for initiating a content distribution using a list that includes the subset of the plurality of identifiers and indicates that the subset is associated with the category.

20. The computer program product of claim 19, wherein the graphical user interface further includes:
a sharing function for the content provider to share the list with another content provider.
